(19) United States
(12) Patent Application Publication
(10) Pub. No.: US 2002/0059284 A1
(43) Pub. Date: May 16, 2002

(54) Method for rapid transfer of data with a multi-spline model

(76) Inventors: Ran Bronstein, Kiryat Ono (IL); Edna Chosack, Kiryat Ono (IL); David Barkay, Kiryat Ono (IL)

Correspondence Address: DR. D'VORAH GRAESER, C/O THE POLKINGHORNS, 9003 FLORIN WAY, UPPER MARLBORO, MD, 20772, US

(21) Appl. No.: 09/982,826

(22) Filed: Oct. 22, 2001

Related U.S. Application Data
(60) Provisional application No. 60/241,837, filed on Oct. 20, 2000.

(51) Int. Cl. G06F 7/00

(52) U.S. Cl. 707/100

(57) ABSTRACT

A method for using multi-spline models for data mapping, particularly for more efficiently transmitting data over a network. Three-dimensional data can be mapped to a model in which one dimension is time. Such data is then transmitted only as required to the user, for example according to the position of the viewed data in time. Thus, the present invention is more efficient and requires lower bandwidth in order to transmit large amounts of data over a network.

### FIELD AND BACKGROUND OF THE INVENTION

The present invention is related to a method for the rapid transfer of data with a multi-spline model, and in particular, to the generation and use of such a model for the rapid transfer of data which can be analyzed according to the dimension of time.

The advent of computer networks, and particularly of the Internet, has increased the possibilities for transmitting data between computers, even in physically distant locations. Such data transfer can be rapid and is therefore a useful tool for communication between computer users. However, increasingly heavy data transfer loads, combined with a relative lack of available bandwidth, particularly for the Internet, continue to frustrate computer users.

In an attempt to increase the rate of data transfer, and therefore reduce the amount of time actually required to transfer such data, various methods have been proposed. For example, data compression methods reduce the amount of data which must be transferred, by increasing the efficiency of transfer, and/or by reducing or “losing” part of the data, for example for “lossy” compression methods. Many of these data compression methods are actually “general” methods, in the sense that they are operative for many different types of data. One disadvantage of such general methods is that they cannot advantageously operate according to specific characteristics of the data for greater efficiency of compression, and hence of data transfer. Other methods which do operate at least partially according to the characteristic(s) of the data have the disadvantage of being specific, such that they cannot be used for all types of data.

One characteristic which is shared by many different types of data is the dimension of time, as many different types of data can be analyzed according to time. For example, video data and audio data are both composed of units which flow according to time. Therefore, such files could easily be decomposed into a plurality of units for data transmission according to time.

Currently, there is no rapid yet general high level method for transmission of three-dimensional data which is able to efficiently decompose data according to time, and hence to permit more rapid, efficient data transmission.

There is therefore a need for, and it would be useful to have, a method for the rapid and efficient transfer of data, which is generally suitable for different types of data analyzable according to time.

### SUMMARY OF THE INVENTION

The present invention is of a method for using multi-spline models for data mapping, particularly for more efficiently transmitting data over a network. Three-dimensional data can be mapped to a model in which one dimension is time. Such data is then transmitted only as required to the user, for example according to the position of the viewed data in time. Thus, the present invention is more efficient and requires lower bandwidth in order to transmit large amounts of data over a network.

According to an embodiment of the present invention, there is provided a method for mapping data to a multi-spline model, the data being expressed in spatial coordinates, the method comprising the steps of: (a) constructing a multi-spline tree from a plurality of splines; (b) converting a spatial coordinate of the data to a time-based coordinate; and (c) mapping each point of the data to a point on the multi-spline model at least partially according to the time-based coordinate.

Hereinafter, the term “network” refers to a connection between any two or more computational devices which permits the transmission of data.

Hereinafter, the term “computational device” includes, but is not limited to, personal computers (PC) having an operating system such as DOS, Windows™, OS/2™ or Linux; Macintosh™ computers; computers having JAVATM™-OS as the operating system; graphical workstations such as the computers of Sun Microsystems™ and Silicon Graphics™, and other computers having some version of the UNIX operating system such as AIX™ or SOLARIS™ of Sun Microsystems™; or any other known and available operating system, or any device, including but not limited to: laptops, hand-held computers, PDA (personal data assistant) devices, cellular telephones, any type of WAP (wireless application protocol) enabled device, wearable computers of any sort, and any device which can be connected to a network as previously defined and which has an operating system. Hereinafter, the term “Windows™” includes but is not limited to Windows95™, Windows NT™, Windows98™, Windows CE™, Windows2000™, and any upgraded versions of these operating systems by Microsoft Corp. (USA).

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could be implemented as software, firmware or hardware, or as a combination thereof. For any of these implementations, the functional steps performed by the method could be described as a plurality of instructions performed by a data processor.

### BRIEF DESCRIPTION OF THE DRAWINGS

The invention is herein described, by way of example only, with reference to the accompanying drawings, wherein:

FIG. 1 is a flowchart of an exemplary method according to the present invention; and

FIG. 2 is a schematic block diagram of an illustrative example for model manipulation according to the present invention.

### DESCRIPTION OF THE PREFERRED EMBODIMENTS

The present invention is of a method for using multi-spline models for data mapping, particularly for more efficiently transmitting data over a network. Three-dimensional data can be mapped to a model in which one dimension is time. Such data is then transmitted only as required to the user, for example according to the position of the viewed data in time. Thus, the present invention is more efficient and requires lower bandwidth in order to transmit large amounts of data over a network.

The term “multi-spline” or “multi-spline model” actually refers to a tree with nodes which are splines themselves. A spline is a curve as represented in three-dimensional space, and is used in the background art for various types of mathematical modeling. In particular, the spline may be used to approximate a local portion of a smooth function which can be represented as a polynomial. A group of such splines may also be used to approximate more portions of the polynomial function, although each such spline is itself a separate entity, with a different continuous derivative. However, the use of a plurality of such splines to construct a tree, or indeed the use of a connected group of splines for constructing any other coherent data model, has not been taught or suggested in the background art.

According to the present invention, the multi-spline tree features a plurality of nodes, each of which is a spline. For each node in the tree, there is an undefined number of children, each of which represents a split in the path of the spline. Each child spline maintains the path of the spline continuously. In addition, the first derivate of the curve is also held to be continuous for each child. This tree of splines can be transferred to a geometric model. The information provided by the multi-spline tree enables the model to be manipulated. For example, the data may be more efficiently modeled, and hence more efficiently transferred, according to the assignment of data to a particular branch of the tree, the distance from the node to the root of the tree, the determined time parameter for each node, and so forth.

The exemplary method described below for modeling, analyzing and more efficiently transferring data according to the multi-spline model has a number of different steps. First, the model for analyzing the data is constructed. Next, the multi-spline tree itself is generated according to the model of the data. Finally, the data itself is mapped to the constructed model, after which the data can optionally be more efficiently transferred through streaming such data. Of course, other uses for the mapped data are also possible and are considered to be within the scope of the present invention.

The principles and operation of the present invention may be better understood with reference to the drawings and the accompanying description, it being understood that these drawings are given for illustrative purposes only and are not meant to be limiting.

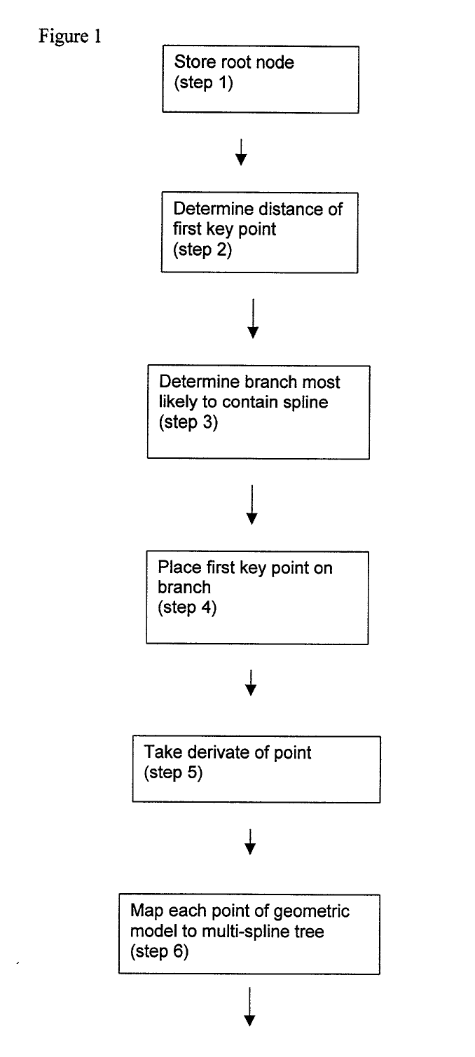

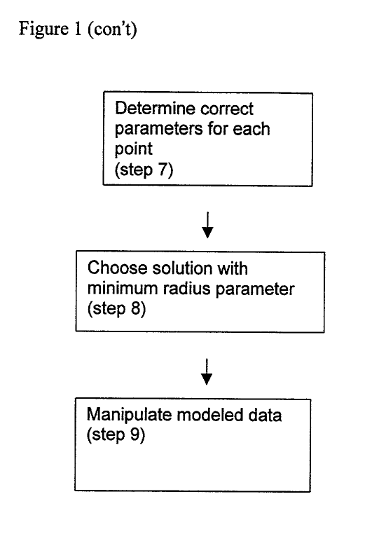

Referring now to the drawings, FIG. 1 is a flowchart of an exemplary method according to the present invention. The method is described according to a plurality of different stages for the purposes of illustration only and without any intention of being limiting.

For the first stage of the exemplary method as shown, the multi-spline tree itself (hereinafter also referred to as the “multi-spline”) is generated. The multi spline is generated from a set of a plurality of single splines, the first of which is considered to be the “root” of the tree. As shown in step 1 of FIG. 1, this root node is stored as a whole node, preferably after being reparameterized by distance, as described in greater detail below. Each subsequent spline, loaded after the first root node, is then added on to the tree according to the following steps. First, as shown in step 2, the distance of the first key point from each of the existing spline nodes is determined for the new spline. In step 3, this distance is used to determine the branch which is most likely to contain this new spline. In step 4, the first key point of the new spline is moved to be placed exactly on the located branch, at the appropriate time parameter. In step 5, the derivate of the new spline is taken from the derivate of the branch at that point, in order to continuously expand the branch. The joint for the new spline can optionally occur at either the mid-portion of a branch or alternatively at the end of such a branch. This process is preferably repeated until all of the splines have been added to the multi-spline tree.

In the next stage of this exemplary method, the data model is mapped to the multi-spline tree. Referring again to FIG. 1, as shown in step 6, each point or vertex of the geometric model must assigned to a branch of the tree. In addition, in step 7, the correct parameters for each point are determined upon assignment. The parameters are as follows: Time on the spline, which may also be considered the distance parameter; Angle around the spline, which is measured on the plane perpendicular to the derivate of the branch at that time; and Radius, which is the distance from the spline to the point at that time. The geometrical model and the multi-spline structure are preferably constructed such that there is a one to one correspondence between vertices of the geometric model in their XYZ representation, to points on the multi-spline tree in their TAR representation.

One example of a suitable method for performing such a mapping stage is as follows. It should be noted that this is an illustrative example only and is given without any intention of being limiting.

The “Path binding” Transform is a class of nonlinear, noninvertible transformations P[λ,\overline{ν}]: [a,b]×R²→R³, where λ: [a,b]→R³ is a given smooth curve, and \overline{ν} is a vector in R³.

The renormalization function is defined as

norm: R³\{0}→R³\{0},norm(ν)=ν/∥ν∥, in which P[λ,\overline{ν}] (Abbreviated as P)

is defined as follows:

P(t,(x, y))=λ(t)+xu(t)+yv(t), with {u(t), v(t), w(t)} being an orthonormal basis,

defined as follows:

w(t)=norm(d80 (t)/dt)

u(t)=norm(\overline{ν}xw(t))

v(t)=norm(w(t)xu(t))

The latter basis is referred to as the Polar base of λ(t).

Although the Path binding transform is generally not invertible, it may still be inverted locally, particularly at points which are a short distance from the curve, by using the following considerations.

For the purpose of inverting the transform, P(t₀, (x₀, y₀))λ, \overline{ν} are all assumed to be known, and while t₀, (x₀, y₀) must be found. The following equation may then be applied:

<P(t₀,(x₀, y₀)),w(t)>=<λ(t₀)+xu(t₀)+yv(t₀),w(t₀)>=<λ(t₀),w(t₀)>

As it is reasonable to assume that the function Δ(t)=<P(t₀,(x₀, y₀))−λ(t), w(t)> is non-constant, and Δ(t₀)=0, the problem is reduced to that of determining the root. There is no general way to decide which root of Δ (in case there is more than one) is indeed the actual t₀, which is where P is not locally invertible. However, sometimes the function can still be inverted under a regularity assumption which is further described below.

Assuming to has been found, the polar basis {u(t₀), v(t₀), w(t₀)} can be calculated, and (x₀, y₀) can be trivially extracted:

x₀=<P(t₀,(x₀, y₀))−λ(t₀), u(t₀)>

y₀=<P(t₀,(x₀, y₀))−λ(t₀), v(t₀)>

Given multiple possible values of t₀, preferably the possible value for which ∥ (x₀, y₀) is minimal, is the value which is selected, thereby forming the previously mentioned “regularity assumption”. Such an assumption has been shown to operate correctly in tested examples for path binding used on three dimensional objects for which intersection with the planes π(t₀)={(t,(x, y))ε[a, b]×R²|t=t₀} yields single, connected and smooth curves, an assumption which is frequently correct for structures such as tubes and pipes, for example.

Preferably, steps 6 and 7 are performed such that each vertex is translated from XYZ coordinates to TAR coordinates by using an advanced iterative algorithm to calculate the time factor and the specific spline, as described in greater detail below.

In step 8, if multiple solutions are obtained, preferably the solution with the minimal radius parameter is chosen. After these steps are performed for each vertex, the geometric model has been fully mapped to the multi-spline tree and the model can optionally be manipulated according to its TAR representation, as described in greater detail for the next stage of the exemplary method.

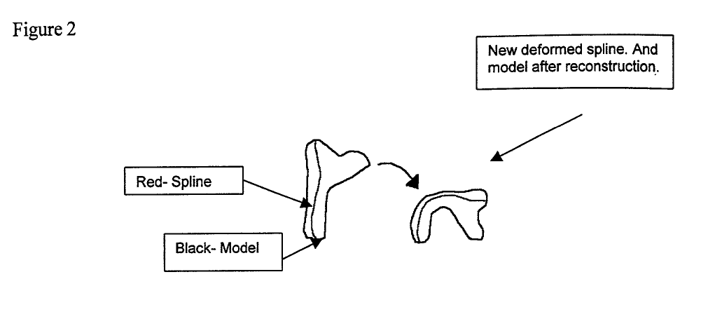

As shown in step 9 of FIG. 1 and as also shown in FIG. 2 below, the stage of manipulation of the modeled data is started by first manipulating the key points of the various branches according to the Time, Angle, and Radius parameters which were previously calculated.

One example of an application for such manipulation is for the simulation of contrast fluid flow under X-ray visualization. If introduction of such fluids is done in some point at the model, the closest spline branch for this point is found. In addition, the Time/Angle/Radius coordinates for this point are found, after which a color (contrast) is assigned to each vertex of the model based on the distance from the point of the injection as described according to time. If a branch in the model is found, the start time for each child spline is naturally the end time of the parent spline, such that the coloring process may be performed recursively throughout the entire spline tree.

A number of optional processes may be performed for manipulation of the multi-spline model, and for general mapping of data to such a model. For example, navigation or movement inside the model is performed similarly as for single spline based objects. However, the only problem which arises from having multiple splines is when a split point at the spline is reached. The decision is based on the direction of navigation within the model. For example, if the model is of a simulated organ with a tool being inserted therein, the direction of navigation is preferably based upon the direction of the tip of the tool being introduced into the model, such as an endoscope, a catheter or any other flexible tool. The direction of navigation is then determined by calculating the distance of the tip of the tool from each of the child splines and choosing the closest spline.

As another example of an optional but preferred process, content can be streamed according to a multi-spline model. Moving along a spline is simply moving forward or backward in the time parameter of the spline. This principle can be used to implement streaming of three-dimensional data in a network, such that data is transferred only as it is required for viewing. As bandwidth is currently the most expensive and important issue for streaming data in a network, clearly a more efficient process would be useful.

According to this preferred embodiment of the present invention, the three-dimensional data is mapped according to the time parameter of the spline. When the user navigates along the spline and advances in time, the data is sent to the user by a server according to that time. Only three-dimensional data that is mapped to the relevant time is transmitted, so the user always receives locally only the required data. This mechanism is able to operate within the framework of multispline models.

What is claimed is:

1. A method for mapping data to a multi-spline model, the data being expressed in spatial coordinates, the method comprising the steps of:
(a) constructing a multi-spline tree from a plurality of splines;
(b) converting a spatial coordinate of the data to a time-based coordinate; and
(c) mapping each point of the data to a point on said multi-spline model at least partially according to said time-based coordinate.

2. The method of claim 1, further comprising the steps of:
(d) determining a location in the data by navigating through said multi-spline model; and
(e) transmitting at least a portion of the data according to said location.
